(19) United States
(12) Patent Application Publication
(10) Pub. No.: US 2026/0063802 A1
(43) Pub. Date: Mar. 5, 2026

(54) SCALABLE GRID BASED IONOSPHERIC CORRECTION SYSTEM AND METHOD

(71) Applicant: HERE GLOBAL B.V., EINDHOVEN (NL)

(72) Inventors: PEKKA-HENRIK NIEMENLEHTO, TAMPERE (FI); SAKARI RAUTALIN, TAMPERE (FI)

(73) Assignee: HERE GLOBAL B.V., EINDHOVEN (NL)

(21) Appl. No.: 18/815,893

(22) Filed: Aug. 27, 2024

(51) Int. Cl. G01S 19/07

(52) U.S. Cl. CPC G01S 19/072

(57) ABSTRACT

A method, apparatus and computer program product are configured to adaptively adjust ionospheric delay correction grids and data transmitted to a navigation device based on identified ionospheric abnormalities.

### TECHNOLOGICAL FIELD

An example embodiment relates generally to the determination of the position of a navigation device utilizing a satellite-based positioning technique and, more particularly, to the adaptive adjustment of atmospheric delay correction data transmitted to the navigation device based on monitoring and identifying abnormal atmospheric activity in the ionosphere and then utilizing a scalable system which may feature multiple grids to correct data transmitted to the navigation device.

### BACKGROUND

Positioning and navigation solutions commonly depend upon a Global Navigation Satellite System (GNSS) with signals transmitted by GNSS satellites being received by GNSS receivers embedded in or otherwise carried by a variety of different devices. For example, smartphones, smart watches, vehicles, drones and other location-aware devices include GNSS receivers in order to allow the position of the device to be determined. In some instances, the device may include a navigation system and/or a navigation application that is dependent upon the signals received by the GNSS receiver in order to determine the position of the device and to provide navigational assistance.

The GNSS family includes several satellite constellations including the Global Positioning System (GPS) and the Globalnaya Navigatsionnaya Sputnikovaya Sistema (GLONASS). Other GNSS satellite constellations include the BeiDou system and the Galileo system. In addition to these global satellite constellations, several regional Satellite-Based Augmentation Systems (SBAS), such as the Quasi-Zenith Satellite System (QZSS), Multifunctional Transport Satellites (MTSAT) Satellite Augmentation System (MSAS), Wide Area Augmentation System (WAAS), European Geostationary Navigation Overlay Service (EGNOS), GPS-Aided Geostationary (GEO) Augmented Navigation (GAGAN), System for Differential Correction and Monitoring (SDCM) and the Indian Regional Navigation Satellite System (IRNSS) having an operational name of NavIC (Navigation with Indian Constellation), have been developed.

In a GNSS system, a navigation satellite orbiting the Earth transmits navigation signals including ranging codes and navigation data interleaved with the ranging codes that a GNSS receiver receives and utilizes to determine the position of the GNSS receiver and, in turn, the device in which the GNSS receiver is embedded. The ranging code allows the GNSS receiver to determine the time required for the signals to travel from the navigation satellite to the GNSS receiver, which correlates to the distance between the navigation satellite and the GNSS receiver. The navigation data includes a set of parameter values of an orbit model defining the orbit of the navigation satellite for a limited period of time. The parameter values provide navigation data known as ephemeris data. The ephemeris data may be utilized by the GNSS receiver to determine the position of the navigation satellite relative to a predefined coordinate system at particular instances of time. Based on the positions of a plurality of navigation satellites, the clock information of the navigation satellites, such as the clock offsets of the navigation satellites relative to GNSS time, and the time required for the signals broadcast by the navigation satellites to be received by the GNSS receiver, the GNSS receiver is configured to determine its position.

The time required for the navigation signals broadcast by the navigation satellites to be received by the GNSS receiver is impacted by several different types of influences that, in turn, can cause an error in the position that is determined for the GNSS receiver. Some receivers, such as low-cost receivers, correct for only a small number of the errors such that the resulting position that is determined has only limited accuracy, such as accuracy within a range of five to ten meters. Other receivers, such as more expensive geodetic receivers, correct for a greater percentage or all of the errors such that the positional accuracy may be to within one centimeter or less.

The various influences that impact the navigation signals transmitted from the navigation satellites to a GNSS receiver can cause errors associated with the satellite clocks, errors associated with the determination of the orbit of the navigation satellite, errors attributable to delays or advances of the navigation signals while propagating through the ionospheric layer, errors associated with delays or advances of the navigation signals while propagating through the tropospheric layer, errors associated with GNSS receiver noise and multipath errors. Although these various sources of error may contribute different amounts to the overall error associated with the position of a GNSS receiver that is determined from the navigation signals, examples of the positional errors attributable to the various sources of error include an error range of +/−2 meters for errors associated with the satellite clocks, an error range for +/−2.5 meters for errors associated with the orbit of the navigation satellite, an error range of +/−5 meters for errors attributable to delays or advances for navigation signals propagating through the ionospheric layer, an error range of 0 to 0.5 meters for delays for navigation signals propagating through the tropospheric layer, an error range for +/−0.3 meters for receiver noise and an error range of 0 to 1 meter for multipath errors.

Furthermore, it is commonly known that standalone GNSS receivers often do not work satisfactorily in urban areas and suffer from fundamental bottlenecks in performance that adversely affect the performance of mass market devices such as smartphones, smartwatches, and/or the like. GNSS was originally designed for outdoor and continuous signal reception uses only. Thus, the GNSS signals and the data link from the satellites to the receivers were not designed for weak signal conditions nor were they configured for the fastest possible time-to-first-fix (TTFF). Also, the fact that the GNSS satellites are very far from the surface of the Earth, (typically in medium Earth orbit at an altitude of 20,000 km) and are solar-powered means that no engineering effort will be enough to overcome the physical limitations related to limited transmission power and to the radio propagation losses impacting the positional accuracy of many navigation devices.

Techniques for improving the performance of GNSS-based positioning have been developed including differential GNSS (D-GNSS), real-time-kinematic technology (RTK), precise point positioning (PPP) and PPP-RTK, as well as techniques that combine other positioning sources to improve performance such as inertial sensor integration, and the analysis of Wi-Fi, Bluetooth or other wireless signals. With respect to PPP, for example, different types of corrections are computed on the basis of data collected by a network of reference stations. The correction data includes corrections for some, but not necessarily all, of satellite orbits and clocks, code biases, phase biases, ionospheric errors and tropospheric errors. The correction data may then be transmitted to navigation devices, such as by a correction service via a network connection, by satellites via the L-band or otherwise. The navigation devices, in turn, can use the correction data to mitigate the effects of different types of errors.

As noted supra, the errors attributable to advances and/or delays of the navigation signals propagating through the ionospheric layer may be the largest source of error in relation to the determination of the position of the navigation device. The error created by the ionosphere or other atmospheric layer is attributable to the interaction of atmospheric particles with the navigation signals propagating therethrough. The propagation speed of the navigation signals within an atmospheric layer and, in turn, the time required for the navigation signals to propagate through the atmospheric layer depends on the electron density therewithin. With respect to the ionosphere, the ionosphere is a dispersive medium such that the effect of the ionosphere on the navigation signals, such as the delay or advance of the navigation signals that is caused by the ionosphere, depends upon both the properties of the navigation signals, such as the frequency of the navigation signals, that are propagating therethrough as well as the respective locations of the navigation satellites and the GNSS receiver. By way of example of the frequency dependency and with respect to the navigation signals utilized by a GNSS-based positioning technique, the code modulations on the carrier waves experience a delay during their propagation through the ionosphere such that the code modulations appear to take longer to reach the GNSS receiver. However, the carrier waves themselves experience an advance during their propagation through the ionosphere such that the carrier waves appear to take less time to reach the GNSS receiver.

As an example of the impact of atmospheric layers on navigation signals, ionospheric delays and advances can be represented by total electron content (TEC) values. TEC values can be mapped to corresponding delays or advances of the navigation signals based on the frequencies of the navigation signals, which are known to the GNSS receiver. TEC values constitute both a vertical TEC (VTEC) and a slant TEC (STEC). The VTEC represents the ionospheric delays or advances in an instance in which the navigation signal is propagating directly downward toward the Earth, that is, in the direction defined by the Earth's gravitational force. The STEC represents the ionospheric delay or advance in an instance in which the navigation signals are propagating at a non-zero angle relative to the direction defined by the Earth's gravitational force, such that the navigation signals are propagating at an angle through the ionospheric layer and are therefore within the ionospheric layer for a longer period of time so as to experience additional delay or advance.

An ionospheric activity model can be defined in various manners. For example, an ionospheric activity model may be defined as a Klobuchar model, a NeQuick model, an IONosphere Map Exchange (IONEX) Global Ionosphere Maps (GIM) model, or a Quasi-Zenith Satellite System (QZSS) model or the ionospheric activity model may be defined by spherical harmonic coefficients. Some models, such as a Klobuchar model, have mutual parameters that apply globally, such that the ionospheric delay or advance at any given location is calculated from the same set of model parameters. Other models, however, are regional with the ionospheric delay or advance calculated utilizing different regional models. For example, the QZSS ionospheric activity model utilizes a plurality of regional models. Ionospheric corrections may therefore be provided for different regions, which leads to a number of grids.

Ionospheric activity models can be based on the expected or predicted behavior of the ionosphere or based on substantially real-time estimations. For example, the Klobuchar model is empirical and is based on an assumption that the ionosphere behaves in a predefined manner. As a result, the Klobuchar model can be relied upon to remove about 50% of the errors attributable to propagation of the navigation signals through the ionosphere. Other models, such as the IONEX GIM model are calculated using observations from GNSS satellites at reference stations. These models assume that the delays or advances of the navigation signals that are attributable to the ionosphere can be estimated from multi-frequency observations at the reference stations. By continuously estimating the delays or advances of the navigation signals caused by the ionosphere for multiple visible navigation satellites at a plurality of reference stations, a model of the TEC in the atmosphere can be created. The TEC model can, in turn, be utilized to estimate the delays or advances of navigation signals at a given time and location. Multiple different global IONEX GIM models are available, such as a rapid solution that is provided with a maximum of 24 hour latency and a predicted solution from both one and two days prior.

The Long Term Evolution (LTE) positioning protocol (LPP) specification defines an ionospheric activity model similar to the QZSS model. In these ionospheric activity models, a grid is defined which is associated with an area of the Earth's surface at which ionospheric correction data will be valid. In this regard, a grid is a collection of data points that covers an area of the Earth's surface. Each point, in turn, may be defined as a two-dimensional coordinate identifying a point on the Earth's surface, such as in terms of latitude and longitude. For each visible satellite within the area, STEC values are defined with the STEC values represented as polynomials and residuals. The STEC value at any point on a gird (known as a data point, grid point, or correction point in various embodiments) can therefore be calculated based upon an evaluation of the polynomial and the residual at the respective grid point. Between the grid points, STEC values may be determined by interpolating between the STEC values at nearby grid points. As each grid is associated with only a certain area, multiple grids may be defined in order to cover larger portions of the Earth or to cover the entire Earth. For the various ionospheric grid models, such as the LPP model and the QZSS model, that are utilized to determine the delays or advances of the navigation signals propagating through the ionosphere, the grid is generally predefined. The STEC values provided by a grid may remain the same over time or may be updated from time to time. At any time, however, the grid utilized by an ionospheric activity model has a static configuration with all of the navigation devices utilizing the same grid. It should be noted that the LPP model is for one time instant only. Thus, there is a spatial model but there is no temporal model meaning that the data needs to be updated regularly to accommodate for the changes in the ionospheric activity and the movement of positioning satellites.

At all times, the atmosphere and changes in atmospheric activity impact the delay and/or advance of navigational signals. The atmosphere, such as the ionosphere, behaves differently around the globe, and, as such, the impact on corresponding navigational signals varies from location to location. Additionally, the differences in the atmospheric activity are directly influenced by the Sun and, therefore, the atmosphere is much more active during the day than during the night. Some of the variations in atmospheric activity are quite predictable, for example the diurnal variations can be estimated well in advance. However, abnormal disruptions to the atmosphere caused, for example, by solar geomagnetic storms due to a coronal mass ejection can lead to major changes in the behavior of the atmosphere. When these rapid and sudden changes in the activity of the atmosphere are not able to be modelled sufficiently, the activity of the atmosphere can decrease the precision of satellite positioning.

### BRIEF SUMMARY

Some embodiments may be described as a computer-implemented method or apparatus comprising generating, by an ionospheric abnormality mitigation system related to a service provider, prediction data, wherein the prediction data comprises one or more ionospheric activity predictions, and wherein the prediction data is generated based at least in part on one or more ionospheric activity models associated with the ionospheric abnormality mitigation system; receiving observation data, wherein the observation data comprises data related to current ionospheric activity associated with a particular geographical area; comparing the prediction data and the observation data; determining, based in part on results of comparing the prediction data and the observation data, that an ionospheric abnormality is adversely affecting one or more navigational signals associated with the particular geographical area, wherein the particular geographical area is associated with two or more correction grids related to the atmospheric delay correction model, wherein the two or more correction grids at least partially overlap; generating ionospheric abnormality mitigation data; and updating at least one of the correction grids with ionospheric abnormality mitigation data, wherein updating at least one of the correction grids comprises executing one or more reconfiguration actions. Another embodiment may feature one or more of the correction grids characterized by a grid layout comprising one or more respective data points.

The one or more reconfiguration actions may, in some embodiments, also comprise updating a correction data update rate defined by the number of client requests received by the service provider for the particular geographical area. In other embodiments, the one or more reconfiguration actions comprise modifying the grid layout associated with a respective correction grid of the one or more correction grids. The one or more reconfiguration actions may yet also comprise creating an additional correction grid which overlaps with the two or more existing correction grids. The one or more reconfiguration actions may yet also comprise generating the action(s) based in part on data point density of a grid for a particular geographical area.

In other embodiments, the computer-implemented method or apparatus may further comprise, in response to determining that an ionospheric abnormality is adversely affecting the one or more navigational signals associated with the particular geographical area, generating one or more warning indicators associated with the ionospheric abnormality and transmitting the one or more warning indicators to one or more requesting devices (e.g., a client) associated with the service provider.

In yet other embodiments, the ionospheric abnormality mitigation system may also comprise one or more machine learning models configured to generate the prediction modeling data. Various models are discussed in FIGS. 1-5 below.

### BRIEF DESCRIPTION OF THE DRAWINGS

Having thus described example embodiments of the present disclosure in general terms, reference will now be made to the accompanying drawings, which are not necessarily drawn to scale, and wherein:

FIG. 1 is a system diagram illustrating the propagation of navigation signals from a navigation satellite to a navigation device, which is also in communication with a service provider;

FIG. 2 is a block diagram of an apparatus that may be specifically configured in accordance with an example embodiment of the present disclosure;

FIG. 3 illustrates a system that provides an exemplary environment related to adaptively improving positioning performance of a navigation device by monitoring and identifying atmospheric abnormalities in accordance with an example embodiment of the present disclosure;

FIG. 4 is a block diagram of the operations performed, such as by the apparatus of FIG. 2 as embodied by a computing device of a service provider, in order to adaptively improve positioning performance of a navigation device being adversely affected by atmospheric abnormalities in accordance with an example embodiment of the present disclosure; and

FIG. 5 is a block diagram of the operations performed, such as by the apparatus of FIG. 2 as embodied by the computing device of the service provider, in order to improve positioning performance of a navigation device by monitoring and identifying atmospheric abnormalities in accordance with an example embodiment of the present disclosure;

FIG. 6 is a diagram depicting an ionospheric abnormality mitigation system;

FIG. 7 is another diagram depicting an ionospheric abnormality mitigation system.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

In the context of a satellite-based positioning technique, such as a GNSS-based positioning technique, a method, apparatus, and computer program product are provided in accordance with an example embodiment in order to facilitate the detection and mitigation of abnormal atmospheric activity (e.g., abnormal activity in the ionosphere) so as to improve the deployment of atmospheric correction data associated with the position of a navigation device otherwise determined by the satellite-based positioning technique. Embodiments of the present disclosure are configured to generate atmospheric correction data in order to compensate for at least some atmospheric delay and/or advance of the navigation signals propagating through the atmosphere. Furthermore, embodiments of the present disclosure comprise an atmospheric abnormality mitigation system configured to monitor atmospheric activity and identify abnormalities in the atmospheric activity that can exacerbate the delay and/or advance of navigation signals propagating through the atmosphere and proactively augment the deployment of atmospheric correction data in response.

As described below, the method, apparatus and computer program product of an example embodiment are configured to provide for the adaptive deployment of correction data generated to correct at least some of the atmospheric delay and/or advance being exacerbated by atmospheric activity, such as abnormal atmospheric activity, affecting navigation signals in a manner that is tailored for a navigation device or other requesting device, that is, a device requesting the correction. In response to detecting one or more abnormalities in the atmosphere (e.g., abnormal activity in the ionosphere, troposphere, etc.), embodiments are configured to define or redefine a grid layout via which correction information is provided in a manner that is requested by the requesting device and/or by providing correction information based upon location parameters associated with the position for which corrections are sought. Embodiments of the present disclosure are configured to adaptively adjust the size and/or or update transmission rate of one or more portions of data related to the defined (or redefined) grid layout, as well as correction data associated with the navigation signals related to the requesting device. In various embodiments, the one or more portions of data related to the grid layout, and/or correction data can be configured as one or more respective data objects configured as digital messages defining the correction data and/or grid layout.

Embodiments of the present disclosure provide the technical benefit of improving the positional accuracy of one or more requesting devices (e.g., navigation devices, smart phones, smartwatches, etc.) being adversely affect by abnormal atmospheric activity. Furthermore, embodiments of the present disclosure provide the technical benefit of reducing the computational resources required by one or more navigation devices (e.g., consumer-grade computing devices comprising navigational components) to accurately calculate and employ correction data associated with navigation signals impacted by atmospheric delay and/or advance. Further still, embodiments of the present disclosure provide the technical benefit of increasing the efficiency of data transmissions executed by the computing devices associated with a service provider by dynamically adjusting the computation and deployment of the correction data by, for example, reconfiguring an atmospheric delay correction model associated with the service provider. It will be appreciated that the aforementioned technological improvements are applicable to a multitude of industries, and that applications of the various methods and operations described herein can be employed to improve technologies related to various industries such as, for example, telecommunication technologies, navigation technologies, logistic technologies, autonomous vehicle technologies, health and safety technologies, and/or the like.

For example, embodiments of the present disclosure provide means to may continuously monitor one or more layers of the atmosphere (e.g., the ionosphere, troposphere, etc.) in order to detect abnormal atmospheric activity (e.g., a solar geomagnetic storm) that can impact the delay and/or advance of navigational signals and, in turn, the positional accuracy of one or more navigation devices. In this regard, embodiments of the present disclosure embody and/or integrate with an atmospheric abnormality mitigation system configured to monitor, model, interpret, predict, compare and/or otherwise analyze one or more portions of atmospheric (e.g., the ionospheric, tropospheric, etc.) activity data in order to provide for reconfiguration of the tools utilized for mitigating abnormal atmospheric activity. For example, as will be described herein, an atmospheric abnormality mitigation system associated with a service provider can determine that a correction data update rate associated with a particular grid (e.g., a data correction grid associated with a particular geographical area) needs to be adjusted (e.g., by increasing or decreasing the correction data update rate). As another example, the atmospheric abnormality mitigation system may determine that the grid layout of one or more correction grids needs to be reconfigured in order to mitigate the abnormal atmospheric activity affecting a particular geographical area. In this regard, the atmospheric abnormality mitigation system can reconfigure the grid layout of the one or more correction grids and transmit the reconfigured correction grids to one or more requesting devices.

Embodiments of the present disclosure are configured to employ multiple different atmospheric modeling techniques simultaneously in order to predict, model, and/or monitor atmospheric activity in order to generate prediction modeling data comprising at least one or more atmospheric activity predictions. For example, an atmospheric abnormality mitigation system associated with a service provider can integrate with, embody, and/or otherwise employ one or more ionospheric activity models including, but not limited to, a Klobuchar model, a NeQuick model, an IONosphere Map Exchange (IONEX) Global Ionosphere Maps (GIM) model, a Quasi-Zenith Satellite System (QZSS) model, and/or a Long Term Evolution (LTE) positioning protocol (LPP). Although described herein in conjunction with delays or advances created by the ionosphere and a corresponding ionospheric activity model, reference to the ionosphere is by way of example, but not of limitation, and the present disclosure is also applicable to the atmosphere in general and to other atmospheric layers including, for example, the troposphere. Additionally or alternatively, various embodiments can employ one or more machine learning models to predict future atmospheric activity given historical atmospheric activity. The one or more machine learning models can include an artificial neural network (ANN), a convolutional neural network (CNN), a recurrent neural network (RNN), or any other type of specially trained neural network that is configured to predict future atmospheric activity. One or more portions of modeled (e.g., predicted) atmospheric activity data generated by the one or more machine learning models and/or the one of the atmospheric activity models listed supra can be configured as prediction modeling data and analyzed by the atmospheric abnormality mitigation system.

Furthermore, embodiments of the present disclosure are configured to integrate with, embody, and/or otherwise communicate with one or more reference stations or other data sources, including sensors, such as spaceborne sensors, configured to monitor one or more parameters associated with one or more respective layers of the atmosphere (e.g., the ionosphere, troposphere, etc.). As such, the subsequent description of one or more reference stations is provided by way of example, but not of limitation, with other data sources also being capable of monitoring one or more parameters associated with one or more layers of the atmosphere and providing observation data in other embodiments. For example, a plurality of reference stations with available GNSS multi-frequency observations, such as dual-frequency observations, can be used to generate one or more portions of observation data. The observation data can include, but is not limited to, the observations themselves and/or calculations of atmospheric activity based on the delays the atmospheric activity cause in the observations made by the reference station or other data source. By continuously estimating the atmospheric activity using the observations, the atmospheric abnormality mitigation system can create a representation of the current state of the atmosphere, e.g., the ionosphere, troposphere, etc., continuously in real-time (or close to real-time). Reference stations or other data sources can estimate the delays or advances of navigation signals caused by the atmosphere, e.g., the ionosphere, troposphere, etc., for multiple visible navigation satellites. Additionally, one or more reference stations or other data sources can be networked together to monitor the atmosphere, e.g., the ionosphere, troposphere, etc., and measure the corresponding atmospheric activity for a large geographical area associated with one or more correction grids. In various embodiments, the atmospheric abnormality mitigation system can be configured to receive observation data from one or more reference stations or other data sources.

The atmospheric abnormality mitigation system is configured to compare prediction modeling data (e.g., predicted ionospheric activity modeled by the one or more respective ionospheric models listed herein) to observation data pursuant to an atmospheric activity comparison technique, such as by execution of an atmospheric activity comparison algorithm. The atmospheric activity comparison technique can be implemented in multiple different ways. For example, the atmospheric activity comparison technique can compare estimated values (e.g., estimated total electron count (TEC) values) at given data points associated with a particular grid. In such an approach, if the differences between the estimated values associated with the respective data points satisfy a predefined threshold, such as by exceeding a certain predefined threshold, it can be assumed that an atmospheric abnormality is occurring. The atmospheric activity comparison technique can also employ one or more machine learning techniques to learn what scales of difference between predicted atmospheric activity (e.g., prediction modeling data) and atmospheric activity measured in real-time (e.g., observation data) are normal and which scales of difference indicate that an atmospheric abnormality is occurring.

When atmospheric abnormalities are detected in the atmosphere, e.g., the ionosphere, troposphere, etc., that cannot be addressed by the atmospheric delay correction models used to deliver correction data to requesting devices with sufficient accuracy and efficiency, the service provider (e.g., by way of the atmospheric abnormality mitigation system) can execute one or more reconfiguration actions to ensure better performance for the requesting devices. In some embodiments, the reconfiguration actions that the service provider can take (e.g., as determined by the atmospheric abnormality mitigation system) to account for the detected atmospheric abnormalities can vary based on which atmospheric models were employed and how severe the detected atmospheric abnormalities are. For example, if the atmospheric abnormality mitigation system determines that the changes in the atmospheric activity are only slightly higher than average, the service provider can choose to increase the correction data update rate until the atmospheric activity is determined to be normal again.

In a circumstance in which the atmosphere is rapidly and/or suddenly changing such that the atmosphere cannot be modelled with sufficient accuracy using a nominal approach (e.g. an LPP grid model with a predetermined correction data update rate and grid layout), the configuration of the corresponding atmospheric delay correction model can be changed. For example, the atmospheric abnormality mitigation system is configured to generate and/or execute one or more reconfiguration actions directed towards reconfiguring an atmospheric delay correction model employed by the service provider. The atmospheric abnormality mitigation system can reconfigure the atmospheric delay correction model employed by the service provider by increasing the correction data update rate and/or modifying a respective grid layout to better represent the current atmospheric activity. In various embodiments, the atmospheric abnormality mitigation system can update various atmospheric delay correction model configuration parameters based on affected geographical areas. For example, the atmospheric abnormality mitigation system can increase the correction data update rate and/or change some other atmospheric delay correction model parameter (e.g., such as a grid layout associated with the affected geographical areas) only in the geographical areas being adversely affected by the atmospheric abnormalities.

Furthermore, in various embodiments, if the atmospheric abnormality mitigation system determines the atmospheric abnormalities to be large, or at least larger than desired, and determines that the adverse effect of the atmospheric abnormalities is increasing over time (and/or is predicted to increase over time), the atmospheric abnormality mitigation system may issue a warning indicator in addition to updating the configuration of the atmospheric delay correction models. The warning indicator can be a digital prompt, alert, and/or message describing that the atmospheric abnormalities may adversely affect the positional accuracy of a navigation device within a certain distance of the geographical areas associated with the atmospheric abnormalities for a certain duration of time. In various embodiments, the atmospheric abnormality mitigation system can automatically cause the issuance of the warning indicator to one or more requesting devices based on the severity of the atmospheric abnormalities. As such, the atmospheric abnormality mitigation system can cause the service provider to transmit the warning indicator to one or more requesting devices associated with the service provider.

Additionally, in various embodiments, if the atmospheric abnormality mitigation system determines that the corrections issued to the one or more requesting devices are worsening the performance of the requesting devices (e.g., worsening the positional accuracy of one or more navigation devices), the service provider (e.g., by way of the atmospheric abnormality mitigation system) can choose not to deliver the corrections and/or mark the corrections as invalid.

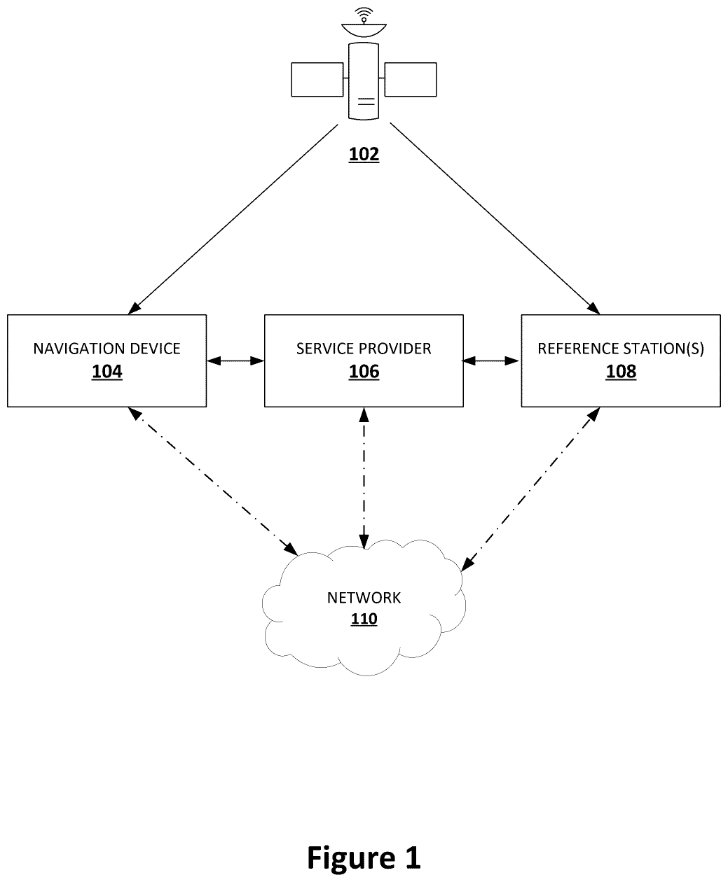

Referring now to FIG. 1, a system 100 that is configured to determine a position, such as the position of a navigation device 104, utilizing a satellite-based positioning technique, such as a GNSS-based positioning technique, is depicted. In this regard, a navigation satellite 102 is depicted that broadcasts data including navigation data to one or more navigation devices. Although a single navigation satellite is depicted for purposes of illustration, the navigation satellite is typically one of a constellation of navigation satellites that orbit the Earth. For example, the navigation satellite may be a GNSS satellite, such as a GPS satellite, a GLONASS satellite, a BeiDou satellite, a Galileo satellite or a regional SBAS satellite. Regardless of the type of navigation satellite, the navigation satellite provides navigation signals that include a ranging code and ephemeris data interleaved with the ranging code that defines the orbit of the navigation satellite during the lifetime of the ephemeris data, such as for a predefined period of time, e.g., 2 to 4 hours. Based upon the ephemeris data, the position of the navigation satellite may be determined within the predefined period of time.

The navigation device 104 that receives the data, including the navigation data, broadcast by the navigation satellite 102 may include a receiver, such as a GNSS receiver, for receiving the signals transmitted by the navigation satellite. The navigation device 104 may be embodied by any of a variety of devices including, for example, a mobile device, such as mobile terminal, e.g., a personal digital assistant (PDA), mobile telephone, smart phone, personal navigation device, smart watch, tablet computer or any combination of the aforementioned and other types of portable computing devices, or a positioning or navigation system such as a positioning or navigation system onboard a vehicle, e.g., an automobile, a truck, a drone, a train, a satellite. Although only a single navigation device 104 is depicted in FIG. 1 for purposes of illustration, a plurality of navigation devices may receive the navigation data from the navigation satellite 102 in other embodiments.

In order to more accurately determine a position, such as the position of the navigation device 104, the system also includes a service provider 106. In the illustrated embodiment, the service provider 106 is in communication with a requesting device and is configured to provide information to the requesting device regarding corrections to be made to compensate for a source of error within the navigation signals and/or the position that is determined. In this regard, the service provider 106 of an example embodiment is configured to provide information to the requesting device regarding corrections to compensate for at least some atmospheric delay and/or advance of the navigation signals transmitted by a navigation satellite 102, such as during the propagation of the navigation signals through the atmosphere, e.g., the ionosphere, troposphere, etc. Although depicted as a discrete element, the service provider 106 of other example embodiments may be provided by a cloud-based computing system, a server system, a distributed computing system, and/or the like.

Although described herein by way of example, but not of limitation, with respect to communication between the service provider 106 and a navigation device 104 in order to improve the position otherwise determined for the navigation device utilizing a satellite-based positioning technique, the service provider may be in communication with and may provide information regarding corrections to be made to various other devices or systems, such as a data provider, a telecommunications provider or the like. As such, the requesting device may be a navigation device in some embodiments but may be other devices or systems in other embodiments, such as a data provider, a telecommunications provider or the like. In an instance in which the requesting device is a data provider, a telecommunications provider or the like, the service provider 106 may provide information regarding corrections to be made at various data points within a region serviced by the data provider, the telecommunications provider or the like such that the data provider, the telecommunications provider or the like can, in turn, provide the information regarding the corrections to be made to downstream devices located within the region such that the downstream devices can compensate for at least some atmospheric delay and/or advance of the navigation signals transmitted by a navigation satellite 102. Additionally or alternatively, the data provider, the telecommunications provider or the like may take into account the information regarding the corrections to be made in relation to its communication with a downstream device. In some embodiments, the requesting device and/or the service provider may be a cloud-based computing device.

Various embodiments are configured to integrate with, embody, and/or otherwise communicate with one or more reference station(s) 108 or other data sources configured to monitor one or more parameters associated with one or more respective layers of the atmosphere (e.g., the ionosphere, troposphere, etc.). For example, a plurality of reference station(s) 108 with available GNSS multi-frequency observations, such as dual-frequency observations, can be used to generate one or more portions of observation data. The observation data can include, but is not limited to, the observations themselves, such as the ranging code, phase, doppler shift, etc., and/or calculations of atmospheric activity based on the delays the atmospheric activity cause in the observations made by the reference station or other data sources, and/or calculations of solar activity affecting the atmosphere, e.g., the ionosphere, troposphere, etc. By continuously estimating the atmospheric activity and/or solar activity using the observations, the atmospheric abnormality mitigation system can create a representation of the current state of the atmosphere, e.g., the ionosphere, troposphere, etc., continuously in real-time (or close to real-time). Reference station(s) 108 or other data sources can estimate the delays or advances of navigation signals caused by the atmosphere, e.g., ionosphere, troposphere, etc., for one or more visible navigation satellite(s) 102. Additionally, one or more reference station(s) 108 or other data sources can be networked together to monitor the atmosphere, e.g., ionosphere, troposphere, etc., and measure the corresponding atmospheric activity for a large geographical area associated with one or more grids. In various embodiments, the atmospheric abnormality mitigation system can be configured to receive observation data from one or more reference station(s) 108 or other data sources.

In various embodiments, the system 100 comprises a network 110. In one or more embodiments, the various components of the system 100 can transmit data, receive data, and/or otherwise communicate via the network 110. The network 110 can be any suitable network or combination of networks and supports any appropriate protocol suitable for communication of data to and from components of the system 100 (e.g., the navigation device 104, the service provider 106, and/or the reference station(s) 108 or other data sources). According to various embodiments, the network 110 includes a public network (e.g., the Internet), a private network (e.g., a network within an organization), or a combination of public and/or private networks. For example, in one or more embodiments, the network 110 is implemented as the Internet, a wireless network, a wired network (e.g., Ethernet), a local area network (LAN), a Wide Area Network (WAN), Bluetooth, Near Field Communication (NFC), or any other type of network that provides communications between one or more components of the various embodiments of the present disclosure. In some embodiments, network 110 is implemented using cellular networks, satellite, licensed radio, or a combination of cellular, satellite, licensed radio, and/or unlicensed radio networks.

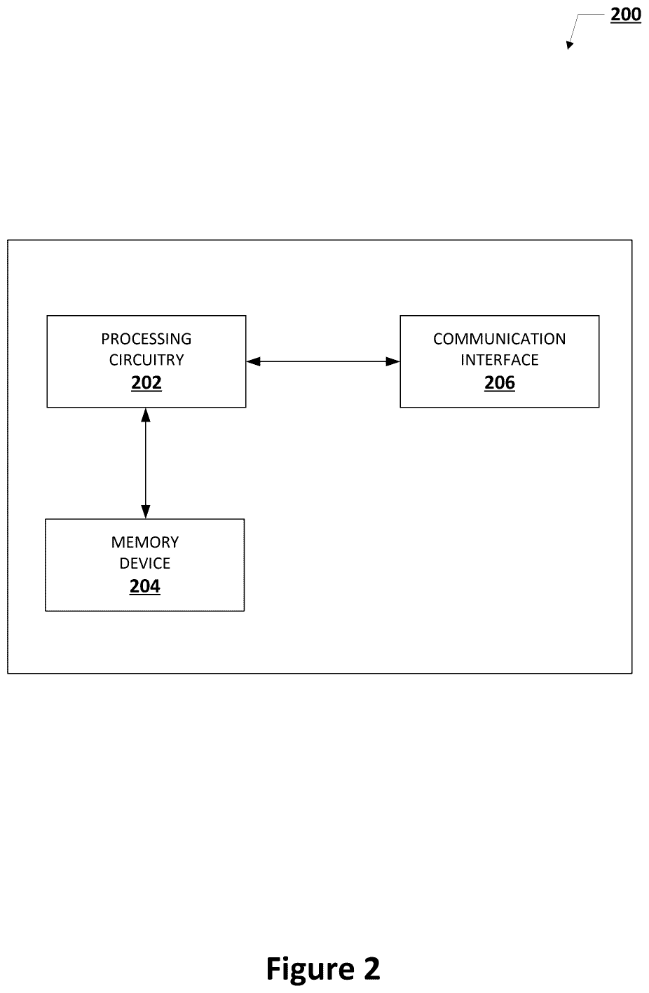

Referring now to FIG. 2, an apparatus 200 that may be configured to facilitate the correction of the position that has been determined, such as for a navigation device 104, so as to compensate for at least some atmospheric delay and/or advance of the navigation signals propagating through the atmosphere, such as the ionosphere, troposphere, etc., is depicted. The apparatus may be embodied by a requesting device, such as the navigation device, a data provider, a telecommunications provider or the like, or may be otherwise associated with the requesting device, such as in an embodiment in which the apparatus is embodied by a computing device in communication with the requesting device that is configured to determine a position, such as the position of the navigation device, or at least corrections to the position. In one embodiment in which the apparatus is embodied by or associated with the requesting device, the apparatus is configured to enable a customized request for corrections to be made, with the corrections being for at least some atmospheric delay and/or advance of the navigation signals relied upon by a satellite-based positioning technique to determine a position, such as the position of the navigation device. In another embodiment in which the apparatus is embodied by or associated with the requesting device, the apparatus is configured to enable a request for corrections to be made by the requesting device with the corrections being for at least some of the atmospheric delay and/or advance experienced by the navigation signals and with the request being at least partially based upon one or more location parameters associated with the position of interest, such as the position of the navigation device. In some embodiments, when the requesting device (e.g., a client, software system, etc.) subscribes for correction data and sends its location to the service an approximate device location is adequate as the updates provided are done on a grid-by-grid basis which may cover large portions of the globe (e.g., hundreds of square kilometers or miles). If the client moves outside of the current grid, the system, apparatus, etc. may then refresh the approximate device location but the location need not be constantly monitored in some embodiments.

Alternatively, the apparatus 200 of other example embodiments may be embodied by a computing device, such as a server in a server system, of a service provider 106, such as a service provider configured to support satellite-based positioning techniques, such as GNSS-based positioning techniques. In one embodiment in which the apparatus is embodied by or associated with a computing device of the service provider, the apparatus is configured to respond to a customized request for corrections from a requesting device, with the corrections being for at least some atmospheric delay and/or advance of the navigation signals relied upon to determine a position, such as the position of the navigation device, in accordance with by a satellite-based positioning technique. In another embodiment in which the apparatus is embodied by or associated with a computing device of the service provider, the apparatus is configured to respond to a request for corrections from a requesting device with the corrections being for at least some of the atmospheric delay and/or advance experienced by the navigation signals and with the request being at least partially based upon one or more location parameters associated with the position for which corrections are sought.

In conjunction with the embodiments in which the apparatus 200 is embodied by or associated with a requesting device as well as the embodiments in which the apparatus is embodied by or associated with a computing device of a service provider 106, the apparatus 200 includes, is associated with or is in communication with processing circuitry 202, a memory device 204 and a communication interface 206, as shown in FIG. 2. In some embodiments, the processing circuitry (and/or co-processors or any other processors assisting or otherwise associated with the processing circuitry) can be in communication with the memory device 204 via a bus for passing information among components of the apparatus 200. The memory device 204 can be non-transitory and can include, for example, one or more volatile and/or non-volatile memories. In other words, for example, the memory device 204 may be an electronic storage device (for example, a computer readable storage medium) comprising gates configured to store data (for example, bits) that can be retrievable by a machine (for example, a computing device like the processing circuitry). The memory device 204 can be configured to store information, data, content, applications, instructions, or the like for enabling the apparatus to carry out various functions in accordance with an example embodiment of the present disclosure. For example, the memory device 204 can be configured to buffer input data for processing by the processing circuitry 202. Additionally or alternatively, the memory device 204 can be configured to store instructions for execution by the processing circuitry 202.

The processing circuitry 202 can be embodied in a number of different ways. For example, the processing circuitry may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry 202 can include one or more processing cores configured to perform independently. A multi-core processor can enable multiprocessing within a single physical package. Additionally or alternatively, the processing circuitry 202 can include one or more processors configured in tandem via the bus to enable independent execution of instructions, pipelining and/or multithreading.

In an example embodiment, the processing circuitry 202 can be configured to execute instructions stored in the memory device 204 or otherwise accessible to the processing circuitry 202. Alternatively or additionally, the processing circuitry 202 can be configured to execute hard coded functionality. As such, whether configured by hardware or software methods, or by a combination thereof, the processing circuitry 202 can represent an entity (for example, physically embodied in circuitry) capable of performing operations according to an embodiment of the present disclosure while configured accordingly. Thus, for example, when the processing circuitry 202 is embodied as an ASIC, FPGA or the like, the processing circuitry 202 can be specifically configured hardware for conducting the operations described herein. Alternatively, as another example, when the processing circuitry 202 is embodied as an executor of software instructions, the instructions can specifically configure the processing circuitry 202 to perform the algorithms and/or operations described herein when the instructions are executed. However, in some cases, the processing circuitry 202 can be a processor of a specific device (for example, a computing device) configured to employ an embodiment of the present disclosure by further configuration of the processor by instructions for performing the algorithms and/or operations described herein. The processing circuitry 202 can include, among other things, a clock, an arithmetic logic unit (ALU) and/or one or more logic gates configured to support operation of the processing circuitry 202.

The apparatus 200 of an example embodiment can also include the communication interface 206. The communication interface 206 can be any means such as a device or circuitry embodied in either hardware or a combination of hardware and software that is configured to receive and/or transmit data from/to other electronic devices in communication with the apparatus 200, such as by providing for communication with the service provider 106 and/or a navigation device 104 or other requesting device of the service provider 106. The communication interface 206 can be configured to communicate in accordance with various wireless protocols including Global System for Mobile Communications (GSM), such as but not limited to Long Term Evolution (LTE). In this regard, the communication interface 206 can include, for example, an antenna (or multiple antennas) and supporting hardware and/or software for enabling communications with a wireless communication network. Additionally or alternatively, the communication interface 206 can include the circuitry for interacting with the antenna(s) to cause transmission of signals via the antenna(s) or to handle receipt of signals received via the antenna(s). In some environments, the communication interface 206 can alternatively or also support wired communication.

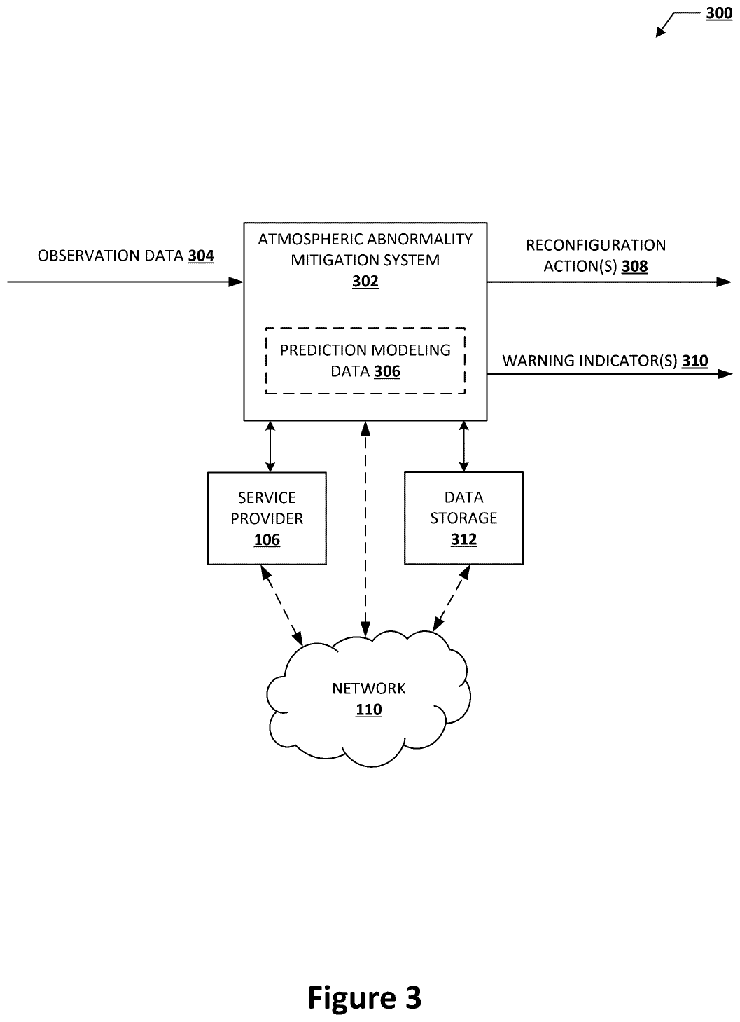

FIG. 3 illustrates a system 300 that provides an exemplary environment according to one or more described features of one or more embodiments of the disclosure. According to an embodiment, the system 300 includes an atmospheric abnormality mitigation system 302 configured to adaptively improve the positioning performance of a navigation device by monitoring and identifying atmospheric abnormalities. In various embodiments, the atmospheric abnormality mitigation system 302 can integrate with, or be embodied by, an apparatus 200 (e.g., an apparatus 200 associated with a service provider 106). In various embodiments, the atmospheric abnormality mitigation system 302 can communicate with the apparatus 200 via the network 110.

In one or more embodiments, the atmospheric abnormality mitigation system 302 receives data from multiple sources including, but not limited to, one or more reference station(s) 108 or other data sources, one or more service provider(s) 106, one or more navigation satellite(s) 102, data storage 312, one or more atmospheric activity model(s), and/or one or more requesting devices. For example, in one or more embodiments, the atmospheric abnormality mitigation system 302 is configured to receive one or more portions of observation data 304 and/or one or more portions of prediction modeling data 306. In one or more embodiments, the atmospheric abnormality mitigation system 302 is configured to receive the one or more portions of observation data 304 and/or the one or more portions of prediction modeling data 306 via the network 110. In some embodiments, the system 302 may receive data from spaceborne and/or earthbound sensors.

In one or more embodiments, the atmospheric abnormality mitigation system 302 is in communication with one or more reference station(s) 108 or other data sources for selectively receiving and/or analyzing one or more portions of observation data 304. For example, a plurality of reference station(s) 108 with available GNSS multi-frequency observations, such as dual-frequency observations, can be used to generate one or more portions of observation data 304. The observation data 304 can include, but is not limited to, observations made by a respective reference station 108, such as the ranging code, phase, doppler shift, etc., calculations of atmospheric activity, e.g., ionospheric activity, based on the delays the ionospheric activity caused in the observations made by a respective reference station 108 or other data source, and/or calculations of solar activity affecting the atmosphere, e.g., ionosphere, troposphere, etc. By continuously estimating the atmospheric activity and/or solar activity using the observations, the atmospheric abnormality mitigation system 302 can create a representation of the current state of the atmosphere, e.g., the ionosphere, troposphere, etc., continuously or repeatedly in real-time (or close to real-time). Reference station(s) 108 or other data sources can estimate the delays or advances of navigation signals caused by the atmosphere, e.g., the ionosphere, troposphere, etc., for one or more visible navigation satellite(s) 102. Additionally, one or more reference station(s) 108 or other data sources can be networked together to monitor the ionosphere and measure the corresponding atmospheric activity for a large geographical area associated with one or more grids. In various embodiments, the atmospheric abnormality mitigation system 302 can be configured to receive observation data 304 from one or more reference station(s) 108 or other data sources via the network 110. The atmospheric abnormality mitigation system 302 may then use the multi-frequency, e.g., dual frequency, observations from reference station(s) 108 or other data sources to determine the atmospheric, e.g., ionospheric or tropospheric, delay.

In various embodiments, the system 300 comprises data storage 312. The data storage 312 can be configured in a number of different ways such as, for example, on-site storage located in an environment associated with the service provider 106 and/or a cloud storage server associated with the service provider 106. In various embodiments, the data storage 312 can comprise one or more data storage devices comprising non-transitory memory for storing and executing one or more operations described herein. In one embodiment, the data storage devices associated with the data storage 312 are embodied in server-class hardware, such as enterprise-level servers. For example, in an embodiment, the data storage 312 comprises any type or combination of application servers, communication servers, web servers, super-computing servers, database servers, file servers, mail servers, proxy servers, and/virtual servers. In various other embodiments, the data storage can be configured as a time series database capable of processing and storing data in real time (e.g., observation data 304 being obtained by one or more reference station(s) 108 or other data sources).

The data storage 312 is configured to store various types of data including, but not limited to, the observation data 304, the prediction modeling data 306, other atmospheric model data, correction data associated with one or more navigational signals, location data, grid data, machine learning model training data, and/or any data associated with the service provider 106, navigation device 104, and/or navigation satellite 102.

The atmospheric abnormality mitigation system 302 is configured to monitor, model, interpret, predict, compare and/or otherwise analyze one or more portions of atmospheric (e.g., the ionospheric or tropospheric) activity data in order to generate reconfiguration action(s) 308 for mitigating abnormal atmospheric activity. In one or more embodiments, the reconfiguration action(s) 308 are generated as a result of a comparison, such as by executing an atmospheric activity comparison algorithm. The atmospheric activity comparison algorithm can compare one or more portions of observation data 304 and/or one or more portions of prediction modeling data 306 in order to generate the reconfiguration action(s) 308.

For example, based on the results of the atmospheric activity comparison the atmospheric abnormality mitigation system 302 associated with a service provider 106 can determine that a correction data update rate associated with a particular grid (e.g., a data correction grid generated by an atmospheric delay correction model and associated with a particular geographical area) needs to be adjusted. As such, the atmospheric abnormality mitigation system 302 can generate a reconfiguration action 308 to increase or decrease the correction data update rate associated with a particular grid. Additionally, the atmospheric abnormality mitigation system 302 may also determine that the grid layout of one or more correction grids needs to be reconfigured in order to mitigate the abnormal atmospheric activity affecting a particular geographical area. In this regard, the atmospheric abnormality mitigation system 302 can reconfigure the grid layout of the one or more correction grids and transmit the reconfigured correction grids to one or more requesting devices.

The atmospheric abnormality mitigation system 302 is configured to employ multiple different atmospheric modeling techniques simultaneously in order to predict, model, and/or monitor atmospheric activity in order to generate prediction modeling data 306 comprising at least one or more atmospheric activity predictions. With respect to the ionosphere, for example, an atmospheric abnormality mitigation system 302 associated with a service provider 106 can integrate with, embody, and/or otherwise employ one or more ionospheric activity models including, but not limited to, a Klobuchar model, a NeQuick model, an IONosphere Map Exchange (IONEX) Global Ionosphere Maps (GIM) model, a Quasi-Zenith Satellite System (QZSS) model, and/or a Long Term Evolution (LTE) positioning protocol (LPP). The one or more ionospheric activity models can represent the various ionospheric delays and advances by TEC values. TEC values can be mapped to corresponding delays or advances of the navigation signals based on the frequencies of the navigation signals, which are known to the GNSS receiver (e.g., navigation device 104). TEC values constitute both a vertical TEC (VTEC) and a slant TEC (STEC). The VTEC represents the ionospheric delays or advances in an instance in which the navigation signal is propagating directly downward toward the Earth, that is, in the direction defined by the Earth's gravitational force. The STEC represents the ionospheric delay or advance in an instance in which the navigation signals are propagating at a non-zero angle relative to the direction defined by the Earth's gravitational force, such that the navigation signals are propagating at an angle through the ionospheric layer and are therefore within the ionospheric layer for a longer period of time so as to experience additional delay or advance.

Additionally or alternatively, the atmospheric abnormality mitigation system 302 can employ one or more machine learning models to predict future atmospheric, e.g., ionospheric, activity based on one or more portions of historical atmospheric, e.g., ionospheric, activity. The one or more machine learning models can include an artificial neural network (ANN), a convolutional neural network (CNN), a recurrent neural network (RNN), or any other type of specially trained neural network that is configured to predict future atmospheric activity. One or more portions of modeled (e.g., predicted) atmospheric activity data generated by the one or more machine learning models and/or the one of the atmospheric activity models listed herein can be configured as prediction modeling data 306 and analyzed by the atmospheric abnormality mitigation system 302. The one or more machine learning models can be trained in part on one or more portions of observation data 304 and/or one or more portions of prediction modeling data 306 configured as model training data and stored in the data storage 310.

The atmospheric abnormality mitigation system 302 is configured to compare prediction modeling data 306 (e.g., predicted ionospheric activity modeled by the one or more respective ionospheric models listed herein) to observation data 304, such as by executing an atmospheric activity comparison algorithm. The atmospheric activity comparison algorithm can be executed in multiple different ways. For example, the atmospheric activity comparison algorithm can compare estimated values (e.g., estimated STEC and/or VTEC values) at given data points associated with a particular grid. In such an approach, if the differences between the estimated values associated with the respective data points exceed a certain predefined threshold, it can be assumed that an atmospheric abnormality is occurring that is affecting the geographical area associated with the particular grid.

The atmospheric activity comparison algorithm executed by the atmospheric abnormality mitigation system 302 can alternatively employ one or more machine learning techniques to learn what scales of difference between predicted atmospheric activity (e.g., prediction modeling data 306) and atmospheric activity measured in real-time (e.g., observation data 304) are normal and which scales of difference indicate that an atmospheric abnormality is occurring. Over time, the one or more machine learning models can be iteratively re-trained based on historical data (e.g., historical prediction modeling data 306 and/or historical observation data 304) such that the one or more machine learning models can become more efficient and/or accurate at determining which scales of difference indicate that an atmospheric abnormality is occurring. Furthermore, the one or more machine learning models can become more efficient and/or accurate at determining optimal reconfiguration action(s) 308 for mitigating the atmospheric abnormality.

In various embodiments, the atmospheric abnormality mitigation system 302 can compare various types of data in various configurations. For example, the atmospheric abnormality mitigation system 302 can compare a set of prediction modeling data 306 to a set of observation data 304 to detect atmospheric abnormalities. Additionally or alternatively, the atmospheric abnormality mitigation system 302 can compare a first set of prediction modeling data 306 to a second set of prediction modeling data 306 to detect atmospheric abnormalities. Additionally or alternatively, the atmospheric abnormality mitigation system 302 can compare a first set of observation data 304 to a second set of observation data 304 to detect atmospheric abnormalities.

When atmospheric abnormalities are detected in the atmosphere, e.g., the ionosphere, troposphere, etc., that cannot be addressed by the atmospheric delay correction models used to deliver correction data to requesting devices (e.g. an LPP grid model) with sufficient accuracy and efficiency, the service provider 106 (e.g., by way of the atmospheric abnormality mitigation system 302) can execute one or more reconfiguration action(s) 308 to ensure better performance for the requesting devices. In some embodiments, the reconfiguration action(s) 308 that the service provider 106 can take (e.g., as determined by the atmospheric abnormality mitigation system 302) to account for the detected atmospheric abnormalities can vary based on which atmospheric models were employed and how severe the detected atmospheric abnormalities are. For example, if the atmospheric abnormality mitigation system 302 determines that the atmospheric abnormalities have a low severity level (e.g., the changes in the ionospheric activity are only slightly higher than average), the service provider 106 can choose to increase the correction data update rate until the atmospheric activity is determined to be normal again. In this regard, the atmospheric abnormality mitigation system 302 is configured to determine (e.g., based on the results of the atmospheric activity comparison algorithm) whether atmospheric abnormalities have a respectively low, moderate, high, and/or critical severity level. The severity level can be determined based on a predicted and/or a measured impact of the atmospheric activity on one or more navigational signals associated with a particular geographical area.

In a circumstance in which the atmosphere, e.g. the ionosphere, troposphere, etc., is rapidly and/or suddenly changing such that the atmosphere, e.g., the ionosphere, troposphere, etc., cannot be modelled with sufficient accuracy using a nominal approach (e.g. an LPP grid model with a predetermined correction data update rate and grid layout), the configuration of the corresponding atmospheric delay correction model can be changed. For example, the atmospheric abnormality mitigation system 302 can be configured to generate and/or execute one or more reconfiguration action(s) 308 directed towards reconfiguring an atmospheric delay correction model employed by the service provider 106. The atmospheric abnormality mitigation system 302 can reconfigure the atmospheric delay correction model employed by the service provider 106 by increasing the correction data update rate and/or modifying a respective grid layout to better represent the current atmospheric activity. In various embodiments, the atmospheric abnormality mitigation system 302 can update various operational parameters associated with the atmospheric delay correction model based on affected geographical areas. For example, the atmospheric abnormality mitigation system 302 can increase the correction data update rate and/or change some other atmospheric delay correction model parameter (e.g., such as a grid layout associated with the affected geographical areas) only in the geographical areas being adversely affected by the atmospheric abnormalities.

Furthermore, in various embodiments, if the atmospheric abnormality mitigation system 302 determines the atmospheric abnormalities to be large and determines that the adverse effect of the atmospheric abnormalities is increasing over time (and/or is predicted to increase over time), the atmospheric abnormality mitigation system 302 may issue a warning indicator 310 in addition to updating the configuration of the atmospheric delay correction models. The warning indicator 310 can be a digital prompt, alert, and/or message describing that the atmospheric abnormalities may adversely affect the positional accuracy of a navigation device within a certain distance of the geographical areas associated with the atmospheric abnormalities for a certain duration of time. In various embodiments, the atmospheric abnormality mitigation system 302 can automatically cause the issuance of the warning indicator 310 to one or more requesting devices based on the severity of the atmospheric abnormalities. As such, the atmospheric abnormality mitigation system 302 can cause the service provider 106 to transmit the warning indicator 310 to one or more requesting devices associated with the service provider 106. In various embodiments, the warning indicator 310 is configured to be rendered via an electronic interface associated with one or more respective requesting devices related to the service provider 106.

Additionally, in various embodiments, if the atmospheric abnormality mitigation system 302 determines that the corrections issued to the one or more requesting devices are worsening the performance of the requesting devices (e.g., worsening the positional accuracy of one or more navigation devices), the service provider 106 (e.g., by way of the atmospheric abnormality mitigation system 302) can choose not to deliver the corrections and/or mark the corrections as invalid.

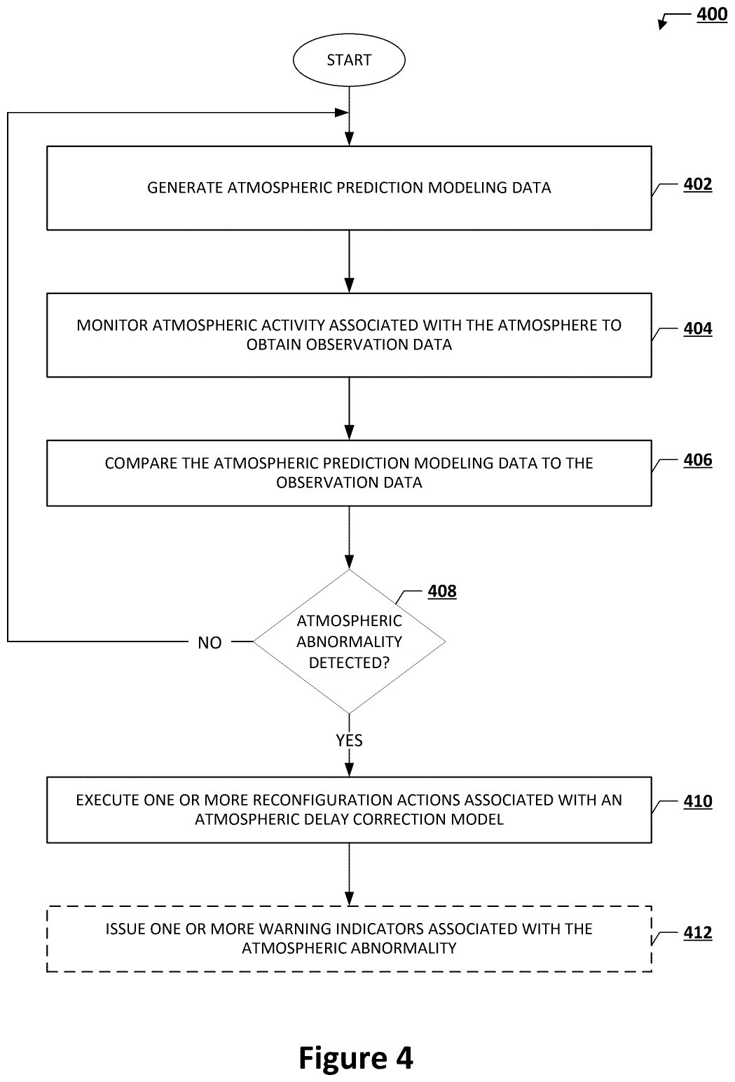

Referring now to FIG. 4, the operations performed, such as by the apparatus 200 of FIG. 2, in accordance with an example embodiment in which the apparatus 200 is embodied by, or associated with, a service provider such as the service provider 106, as depicted. Additionally or alternatively, the apparatus 200 can integrate with or, in various embodiments, embody the atmospheric abnormality mitigation system 302 such that the apparatus 200 can perform one or more functions associated with the atmospheric abnormality mitigation system 302. By way of example, the methods and operations described in the following examples will be described from the perspective of the apparatus 200. In this regard, the apparatus 200 is configured to execute a method 400 for adaptively improving positioning performance of a navigation device.

At block 402 of FIG. 4, the apparatus 200 includes means, such as the processing circuitry 202, memory device 204, and/or the like, configured to generate atmospheric prediction modeling data. For example, the apparatus 200 (e.g., in conjunction with the atmospheric abnormality mitigation system 302) is configured to employ multiple different atmospheric, e.g., ionospheric, modeling techniques simultaneously in order to predict, model, and/or monitor atmospheric, e.g., ionospheric, activity in order to generate prediction modeling data 306 comprising at least one or more atmospheric activity predictions. With respect to the ionosphere, for example, an atmospheric abnormality mitigation system 302 associated with a service provider 106 can integrate with, embody, and/or otherwise employ one or more ionospheric activity models including, but not limited to, a Klobuchar model, a NeQuick model, an IONosphere Map Exchange (IONEX) Global Ionosphere Maps (GIM) model, a Quasi-Zenith Satellite System (QZSS) model, and/or a Long Term Evolution (LTE) positioning protocol (LPP) in order to generate prediction modeling data 306. Additionally or alternatively, the atmospheric abnormality mitigation system 302 can employ one or more machine learning models to predict future atmospheric activity based on one or more portions of historical atmospheric activity. One or more portions of modeled (e.g., predicted) ionospheric activity data generated by the one or more machine learning models and/or the one of the atmospheric activity models listed herein can be configured as prediction modeling data 306 and analyzed by the atmospheric abnormality mitigation system 302.

At block 404, the apparatus 200 includes means, such as the processing circuitry 202, memory device 204, and/or the like, configured to monitor atmospheric activity associated with the atmosphere, e.g., the ionosphere, troposphere, etc., to obtain observation data. For example, the apparatus 200 (e.g., in conjunction with the atmospheric abnormality mitigation system 302) can be in communication with one or more reference station(s) 108 for selectively receiving and/or analyzing one or more portions of observation data 304. For example, a plurality of reference station(s) 108 with available GNSS multi-frequency, such as dual-frequency, observations can be used to generate one or more portions of observation data 304. The observation data 304 can include, but is not limited to, observations made by a respective reference station 108, such as the ranging code, phase, doppler shift, etc., calculations of atmospheric, e.g., ionospheric, tropospheric, etc., activity based on the delays the atmospheric activity causes in the observations made by a respective reference station 108 or other data source, and/or calculations of solar activity affecting the atmosphere, e.g., the ionosphere, troposphere, etc.

By continuously estimating the atmospheric activity and/or solar activity using the observation data, the atmospheric abnormality mitigation system 302 can create a representation of the current state of the atmosphere, e.g., the ionosphere, troposphere, etc., continuously in real-time (or close to real-time). Reference station(s) 108 or other data sources can estimate the delays or advances of navigation signals caused by the ionosphere for one or more visible navigation satellite(s) 102 (or provide data from which the delays or advances of navigation signals caused by the ionosphere can be determined). Additionally, one or more reference station(s) 108 or other data sources can be networked together to monitor the atmosphere and measure the corresponding atmospheric activity for a large geographical area associated with one or more grids. In various embodiments, the atmospheric abnormality mitigation system 302 can be configured to receive observation data 304 from one or more reference station(s) 108 or other data sources via the network 110.

At block 406, the apparatus 200 includes means, such as the processing circuitry 202, memory device 204, and/or the like, configured to compare the atmospheric prediction modeling data to the observation data. For example, the apparatus 200 (e.g., in conjunction with the atmospheric abnormality mitigation system 302) is configured to compare prediction modeling data 306 (e.g., predicted ionospheric activity modeled by the one or more respective ionospheric models and/or machine learning models) to observation data 304, such as by executing an atmospheric activity comparison algorithm. The atmospheric activity comparison algorithm can be executed in multiple different ways. For example, the atmospheric activity comparison algorithm can compare estimated values (e.g., estimated STEC and/or VTEC values) at given data points associated with a particular grid. In such an approach, if the differences between the estimated values associated with the respective data points exceed a certain predefined threshold, it can be assumed that an atmospheric abnormality is occurring that is affecting the geographical area associated with the particular grid.

The atmospheric activity comparison algorithm can alternatively employ one or more machine learning techniques to learn what scales of difference between predicted atmospheric activity (e.g., prediction modeling data 306) and atmospheric activity measured in real-time (e.g., observation data 304) are normal and which scales of difference indicate that an atmospheric abnormality is occurring.

In various embodiments, the atmospheric activity comparison algorithm executed by the atmospheric abnormality mitigation system 302 can compare various types of data in various configurations. For example, the atmospheric abnormality mitigation system 302 can compare a set of prediction modeling data 306 to a set of observation data 304 to detect atmospheric abnormalities. Additionally or alternatively, the atmospheric abnormality mitigation system 302 can compare a first set of prediction modeling data 306 to a second set of prediction modeling data 306 to detect atmospheric abnormalities. Additionally or alternatively, the atmospheric abnormality mitigation system 302 can compare a first set of observation data 304 to a second set of observation data 304 to detect atmospheric abnormalities.

At block 408, the apparatus 200 includes means, such as the processing circuitry 202, memory device 204, and/or the like, configured to determine whether an atmospheric abnormality has been detected. For example, based on the results of the atmospheric activity comparison algorithm executed by the apparatus 200 (e.g., in conjunction with the atmospheric abnormality mitigation system 302), the apparatus 200 can determine whether an atmospheric abnormality is affecting the propagation of one or more navigational signals (e.g., transmitted by the navigation satellite 102) associated with a particular geographical area. The particular geographical area can be associated with one or more correction grids related to an atmospheric delay correction model employed by the service provider 106, and the one or more grids can be characterized by a grid layout comprising one or more respective data points (also termed as grid points or correction points). If it is determined that an atmospheric abnormality affecting the particular geographical area is indeed occurring, the method 400 proceeds to block 410. In various embodiments, if no atmospheric abnormality has been detected, the method 400 returns to the start and the operations associated with blocks 402-406 are repeated.

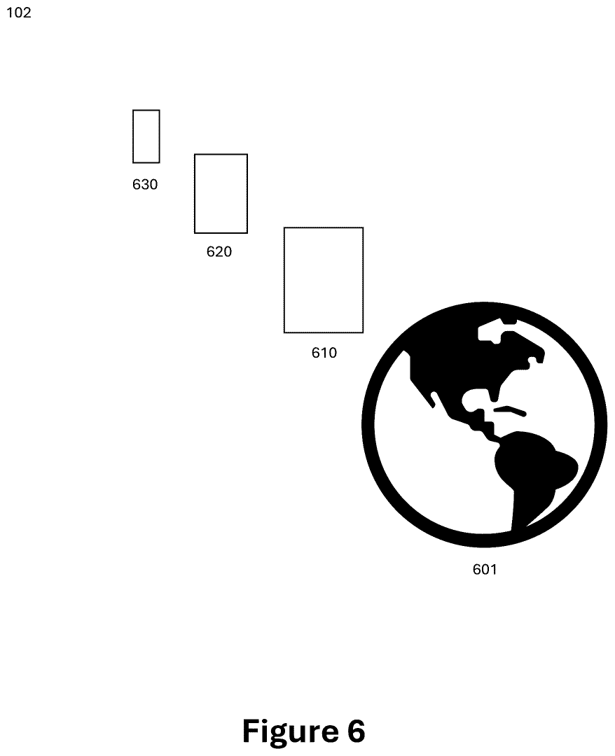

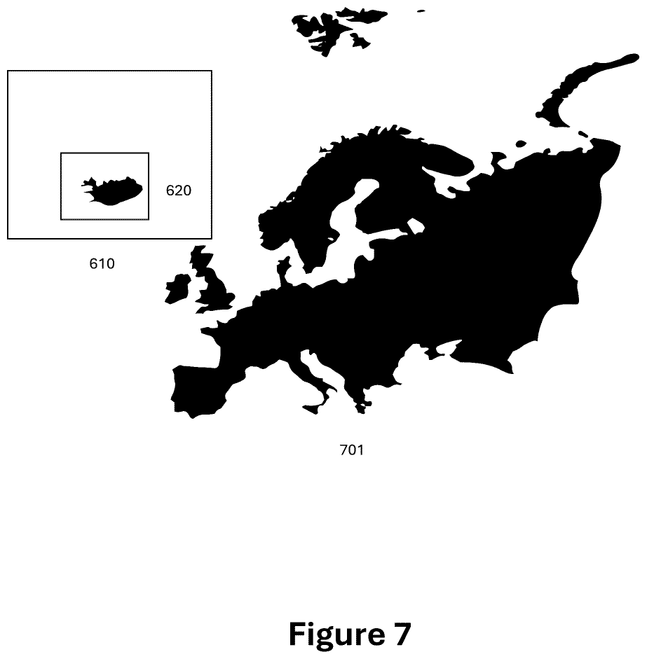

At block 410, the apparatus 200 includes means, such as the processing circuitry 202, memory device 204, and/or the like, configured to execute one or more reconfiguration actions associated with an atmospheric delay correction model. For example, based on the results of the atmospheric activity comparison algorithm the apparatus 200 (e.g., in conjunction with the atmospheric abnormality mitigation system 302) associated with a service provider 106 can determine that a correction data update rate associated with a particular grid (e.g., a data correction grid generated by an atmospheric delay correction model and associated with a particular geographical area) needs to be adjusted. As such, the atmospheric abnormality mitigation system 302 can generate a reconfiguration action 308 to increase or decrease the correction data update rate associated with a particular grid. Additionally, the atmospheric abnormality mitigation system 302 may also determine that the grid layout of one or more correction grids needs to be reconfigured in order to mitigate the abnormal atmospheric activity affecting a particular geographical area. In this regard, the atmospheric abnormality mitigation system 302 can reconfigure the grid layout of the one or more correction grids and transmit the reconfigured correction grids to one or more requesting devices. The reconfiguration action noted above may, in some embodiments, include changing one or more grids' geographic coverage area, the grid size/shape, the grid size in terms of the number of data points, and/or the spacing between these data points. For example, in an area where high resolution positioning is needed a grid with 100 data points may be reconfigured to 1000 data points within the grid layout to provide the level of accuracy needed for a given implementation. In some cases, additional grids may also be created by the system, apparatus, etc. to correct for ionospheric interference and these new grids may be updated more frequently than the other grids maintained by the system (see FIGS. 6 and 7 below).

In various embodiments, the one or more reconfiguration action(s) 308 may be generated based in part on a severity level associated with the atmospheric abnormality affecting the particular geographical area. In some embodiments, the reconfiguration action(s) 308 that the service provider can take (e.g., as determined by the atmospheric abnormality mitigation system 302) to account for the detected atmospheric abnormalities can vary based on which atmospheric models, such as ionospheric models (e.g., an LPP grid model), were employed and how severe the detected atmospheric abnormalities are. For example, if the atmospheric abnormality mitigation system 302 determines that the atmospheric abnormalities have a low severity level (e.g., the changes in the ionospheric activity are only slightly higher than average), the service provider 106 can choose to increase the correction data update rate until the atmospheric activity, e.g., the ionospheric activity, is determined to be normal again. In this regard, the atmospheric abnormality mitigation system 302 is configured to determine (e.g., based on the results of the atmospheric activity comparison algorithm) whether atmospheric abnormalities have a respectively low, moderate, high, and/or critical severity level. The severity level can be determined based on a predicted and/or a measured impact of the atmospheric activity on one or more navigational signals associated with a particular geographical area.

In various embodiments, the one or more reconfiguration action(s) 308 comprise modifying one or more operational parameters of the atmospheric delay correction model. For example, in various embodiments a service provider 106 may employ a grid-based atmospheric delay correction model (e.g., an atmospheric delay correction model utilizing LPP techniques) that utilizes one or more polynomial models for generating atmospheric correction data for one or more grids comprising one or more respective data points. As such, in various embodiments, the atmospheric abnormality mitigation system 302 is configured to modify one or more operational parameters associated with the atmospheric delay correction model. For example, the atmospheric abnormality mitigation system 302 can generate a reconfiguration action 308 directed towards updating, modifying, and/or otherwise augmenting the polynomial model used to generate the correction data by, for example, adjusting the degree of the polynomial, adjusting the coefficients associated with the polynomial model, adjusting the residuals associated with the polynomial model, augmenting the data points associated with the correction grid in order to better fit the polynomial model, and/or the like.

At optional block 412, the apparatus 200 includes means, such as the processing circuitry 202, memory device 204, communication interface 206, and/or the like, configured to issue one or more warning indicators associated with the atmospheric abnormality. For example, in various embodiments, if the apparatus 200 (e.g., in conjunction with the atmospheric abnormality mitigation system 302) determines the atmospheric abnormalities to be large, such as by exceeding a predefined threshold, and determines that the adverse effect of the atmospheric abnormalities is increasing over time (and/or is predicted to increase over time), the atmospheric abnormality mitigation system 302 may issue a warning indicator 310 in addition to updating the configuration of the atmospheric delay correction models. The warning indicator 310 can be a digital prompt, alert, and/or message describing that the atmospheric abnormalities may adversely affect the positional accuracy of a navigation device within a certain distance of the geographical areas associated with the atmospheric abnormalities for a certain duration of time. In various embodiments, the atmospheric abnormality mitigation system 302 can automatically cause the issuance of the warning indicator 310 to one or more requesting devices based on the severity of the atmospheric abnormalities. As such, the atmospheric abnormality mitigation system 302 can cause the service provider 106 to transmit the warning indicator 310 to one or more requesting devices associated with the service provider 106. In various embodiments, the warning indicator 310 is configured to be rendered via an electronic interface associated with one or more respective requesting devices related to the service provider 106.

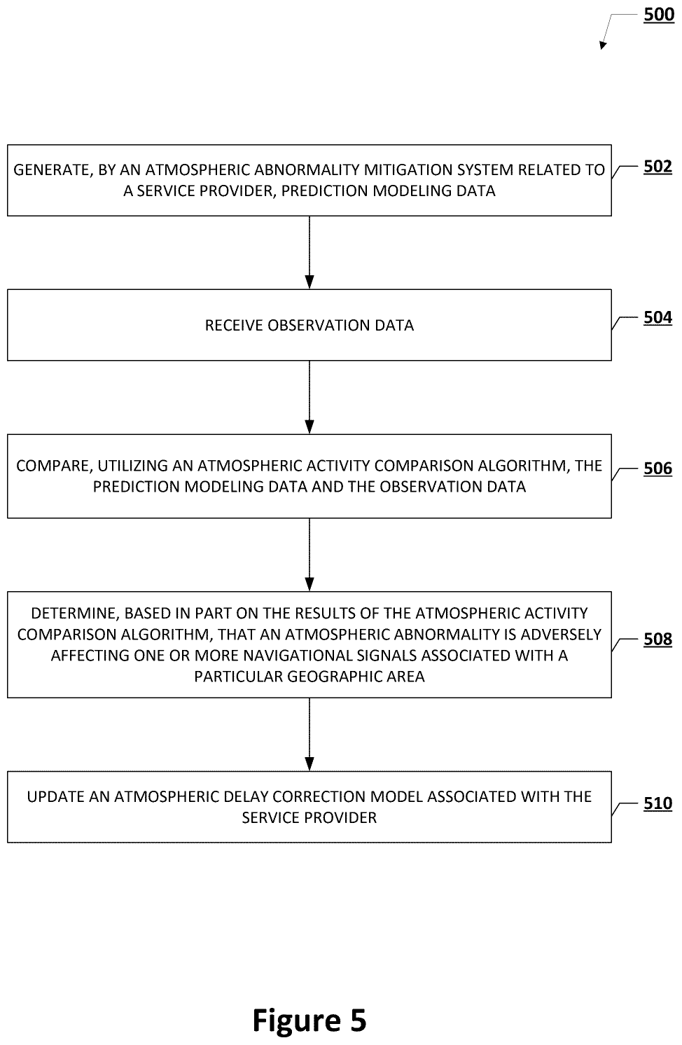

Referring now to FIG. 5, the operations are performed, such as by the apparatus 200 of FIG. 2, in accordance with an example embodiment in which the apparatus 200 is embodied by, or associated with, a service provider such as the service provider 106. Additionally or alternatively, the apparatus 200 can integrate with or, in various embodiments, embody the atmospheric abnormality mitigation system 302 such that the apparatus 200 can perform one or more functions associated with the atmospheric abnormality mitigation system 302. In order to simplify the description, the methods and operations described in the following examples will be described from the perspective of the apparatus 200. In this example, the apparatus 200 is configured to execute a method 500 for adaptively improving positioning performance of a navigation device by monitoring and identifying atmospheric abnormalities.

At block 502 of FIG. 5, the apparatus 200 includes means, such as the processing circuitry 202, memory device 204, and/or the like, configured to generate, by an atmospheric abnormality mitigation system related to a service provider, prediction modeling data, where the prediction modeling data comprises one or more atmospheric activity predictions, e.g., ionospheric activity predictions, and where the prediction modeling data is generated based at least in part on one or more atmospheric activity models, e.g., ionospheric activity models, associated with the atmospheric abnormality mitigation system. For example, the atmospheric abnormality mitigation system 302 is configured to employ multiple different atmospheric, e.g., ionospheric, modeling techniques simultaneously in order to predict, model, and/or monitor atmospheric, e.g., ionospheric, activity in order to generate prediction modeling data 306 comprising at least one or more atmospheric activity predictions, e.g., ionospheric activity predictions. With respect to the ionosphere, for example, an atmospheric abnormality mitigation system 302 associated with a service provider 106 can integrate with, embody, and/or otherwise employ one or more ionospheric activity models including, but not limited to, a Klobuchar model, a NeQuick model, an IONosphere Map Exchange (IONEX) Global Ionosphere Maps (GIM) model, a Quasi-Zenith Satellite System (QZSS) model, and/or a Long Term Evolution (LTE) positioning protocol (LPP) in order to generate prediction modeling data 306. Additionally or alternatively, the atmospheric abnormality mitigation system 302 can employ one or more machine learning models to predict future atmospheric activity based one or more portions of historical atmospheric activity. One or more portions of modeled (e.g., predicted) atmospheric activity data generated by the one or more machine learning models and/or the one of the atmospheric activity models listed herein can be configured as prediction modeling data 306 and analyzed by the atmospheric abnormality mitigation system 302.

At block 504, the apparatus 200 includes means, such as the processing circuitry 202, memory device 204, communication interface 206, and/or the like, configured to receive, from one or more reference stations or other data sources, observation data, where the observation data comprises data related to current atmospheric activity, e.g., ionospheric and/or tropospheric activity associated with a particular geographical area. For example, the atmospheric abnormality mitigation system 302 can be in communication with one or more reference station(s) 108 for selectively receiving and/or analyzing one or more portions of observation data 304. For example, a plurality of reference station(s) 108 with available GNSS multi-frequency observations, such as dual-frequency observations, can be used to generate one or more portions of observation data 304. The observation data 304 can include, but is not limited to, observations made by a respective reference station 108 or other data source, such as the ranging code, phase, doppler shift, etc., calculations of atmospheric, e.g., ionospheric and/or tropospheric, activity based on the delays the atmospheric, e.g., ionospheric and/or tropospheric, activity causes in the observations made by a respective reference station 108 or other data source, and/or calculations of solar activity affecting the ionosphere.

By continuously estimating the atmospheric activity and/or solar activity using the observations, the atmospheric abnormality mitigation system 302 can create a representation of the current state of the atmosphere, e.g., the ionosphere, troposphere, etc., continuously in real-time (or close to real-time). Reference station(s) 108 or other data sources can estimate the delays or advances of navigation signals caused by the atmosphere, e.g., the ionosphere, troposphere, etc., for one or more visible navigation satellite(s) 102 (or provide the observation data from which the delays or advances can be determined). Additionally, one or more reference station(s) 108 or other data sources can be networked together to monitor the atmosphere, e.g., the ionosphere, troposphere, etc., and measure the corresponding atmospheric activity for a large geographical area associated with one or more grids. In various embodiments, the atmospheric abnormality mitigation system 302 can be configured to receive observation data 304 from one or more reference station(s) 108 or other data sources via the network 110.

At block 506, the apparatus 200 includes means, such as the processing circuitry 202, memory device 204, and/or the like, configured to compare, such as by utilizing an atmospheric activity comparison algorithm, the prediction modeling data and the observation data. For example, the atmospheric abnormality mitigation system 302 is configured to compare prediction modeling data 306 (e.g., predicted ionospheric activity modeled by the one or more respective ionospheric models and/or machine learning models) to observation data 304, such as by executing an atmospheric activity comparison algorithm. The atmospheric activity comparison algorithm can be executed in multiple different ways. For example, the atmospheric activity comparison algorithm can compare estimated values (e.g., estimated STEC and/or VTEC values) at given data points associated with a particular grid. In such an approach, if the differences between the estimated values associated with the respective data points exceed a certain predefined threshold, it can be assumed that an atmospheric abnormality is occurring that is affecting the geographical area associated with the particular grid.

The atmospheric activity comparison algorithm can alternatively employ one or more machine learning techniques to learn what scales of difference between predicted atmospheric activity (e.g., prediction modeling data 306) and atmospheric activity measured in real-time (e.g., observation data 304) are normal and which scales of difference indicate that an atmospheric abnormality is occurring.

In various embodiments, the atmospheric activity comparison algorithm executed by the atmospheric abnormality mitigation system 302 can compare various types of data in various configurations. For example, the atmospheric abnormality mitigation system 302 can compare a set of prediction modeling data 306 to a set of observation data 304 to detect atmospheric abnormalities. Additionally or alternatively, the atmospheric abnormality mitigation system 302 can compare a first set of prediction modeling data 306 to a second set of prediction modeling data 306 to detect atmospheric abnormalities. Additionally or alternatively, the atmospheric abnormality mitigation system 302 can compare a first set of observation data 304 to a second set of observation data 304 to detect atmospheric abnormalities.

At block 508, the apparatus 200 includes means, such as the processing circuitry 202, memory device 204, and/or the like, configured to determine, such as based in part on the results of the atmospheric activity comparison algorithm, that an atmospheric abnormality is adversely affecting one or more navigational signals associated with the particular geographical area. For example, based on the results of the atmospheric activity comparison algorithm, the atmospheric abnormality mitigation system 302 can determine whether an atmospheric abnormality is affecting the propagation of one or more navigational signals (e.g., transmitted by the navigation satellite 102) associated with a particular geographical area. The particular geographical area can be associated with one or more correction grids related to an atmospheric delay correction model employed by the service provider 106, and the one or more correction grids can be characterized by a grid layout comprising one or more respective data points.

At block 510, the apparatus 200 includes means, such as the processing circuitry 202, memory device 204, and/or the like, configured to update an atmospheric delay correction model associated with the service provider, such as by executing one or more reconfiguration actions. For example, based on the results of the atmospheric activity comparison algorithm the atmospheric abnormality mitigation system 302 associated with a service provider 106 can determine that a correction data update rate associated with a particular grid (e.g., a data correction grid generated by an atmospheric delay correction model and associated with a particular geographical area) needs to be adjusted. As such, the atmospheric abnormality mitigation system 302 can generate a reconfiguration action 308 to increase or decrease the correction data update rate associated with a particular grid. Additionally, the atmospheric abnormality mitigation system 302 may also determine that the grid layout of one or more correction grids needs to be reconfigured in order to mitigate the abnormal atmospheric activity affecting a particular geographical area. In this regard, the atmospheric abnormality mitigation system 302 can reconfigure the grid layout of the one or more correction grids and transmit the reconfigured correction grids to one or more requesting devices.

In various embodiments, the one or more reconfiguration action(s) 308 comprise modifying one or more operational parameters of the atmospheric delay correction model. For example, in various embodiments a service provider 106 may employ a grid-based atmospheric delay correction model (e.g., an atmospheric delay correction model utilizing LPP techniques) that utilizes one or more polynomial models for generating atmospheric correction data for one or more grids comprising one or more respective data points. As such, in various embodiments, the atmospheric abnormality mitigation system 302 is configured to modify one or more operational parameters associated with the atmospheric delay correction model. For example, the atmospheric abnormality mitigation system 302 can generate a reconfiguration action 308 directed towards updating, modifying, and/or otherwise augmenting the polynomial model used to generate the correction data by, for example, adjusting the degree of the polynomial, adjusting the coefficients associated with the polynomial model, adjusting the residuals associated with the polynomial model, augmenting the data points associated with the correction grid in order to better fit the polynomial model, and/or the like.

Embodiments of the present disclosure therefore provide the technical benefit of improving the positional accuracy of one or more requesting devices (e.g., navigation devices, smart phones, smartwatches, etc.) being adversely affect by abnormal atmospheric activity. Furthermore, embodiments of the present disclosure provided the technical benefit of reducing the computational resources required by one or more navigation devices (e.g., consumer-grade computing devices comprising navigational components) to accurately calculate and employ correction data associated with navigation signals impacted by atmospheric delay and/or advance. Further still, embodiments of the present disclosure provide the technical benefit of increasing the efficiency of data transmissions executed by the computing devices associated with a service provider by dynamically adjusting the computation and deployment of the correction data by, for example, reconfiguring an atmospheric delay correction model associated with the service provider. It will be appreciated by one or more persons of ordinary skill in the art that the aforementioned technological improvements are applicable to a multitude of industries, and that applications of the various methods and operations described herein can be employed to improve technologies related to various industries such as, for example, telecommunication technologies, navigation technologies, logistic technologies, autonomous vehicle technologies, health and safety technologies, and/or the like.

As described herein, FIGS. 4 and 5 are flow diagrams of an apparatus 200, method, and computer program product configured to allow requests for information associated with atmospheric corrections to be tailored, such as based upon the requirements and/or the position of the navigation device 104 according to an example embodiment. It will be understood that each block of the flow diagrams, and combinations of blocks in the flow diagrams, may be implemented by various means, such as hardware, firmware, processing circuitry 202, and/or other devices associated with execution of software including one or more computer program instructions. For example, one or more of the procedures described herein may be embodied by computer program instructions. In this regard, the computer program instructions which embody the procedures described herein may be stored by the memory device 204 of the apparatus and executed by the processing circuitry or the like. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the blocks of the flow diagrams. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the blocks of the flow diagrams.

Accordingly, blocks of the flow diagrams support combinations of means for performing the specified functions and combinations of operations for performing the specified functions. It will also be understood that one or more blocks of the flow diagrams, and combinations of blocks in the flow diagrams, can be implemented by special purpose hardware-based computer systems which perform the specified functions, or combinations of special purpose hardware and computer instructions.

In some embodiments, certain ones of the operations may be modified or further amplified. Furthermore, in some embodiments, additional optional operations may be included. Modifications, additions, or amplifications to the operations may be performed in any order and in any combination.

As mentioned above, the presently disclosed embodiments may include systems, methods, etc. which account for atmospheric interference with positioning data. In some embodiments this interference may specifically relate to ionospheric interference and examples of such interference are shown in FIGS. 6 and 7. It should be noted that the functionality discussed and shown in FIGS. 1-5 may be understood to account for ionospheric abnormalities and thus be utilized as part of one or more ionospheric abnormality mitigation systems. Any of the data modeling and/or mitigation techniques discussed for atmospheric anomaly correction in FIGS. 1-5 may be used in whole or in part for the ionospheric abnormality mitigation system(s) shown in FIGS. 6-7 and vice versa.

FIG. 6 is a diagram depicting an ionospheric abnormality mitigation system. In this figure, a client using the mitigation/correction service requests ionospheric correction data and in doing so provides an approximate location. This approximate location is used to determine which grid(s) may be utilized to provide corrected data to the client (e.g., an end user device, software application, etc.). In the example show, three grids 610, 620, and 630 cover an area on Earth 601 from which the ionospheric correction request came from. In this example, the ionospheric abnormality mitigation system may feature a series of grids which are stacked and/or overlap upon one another. The lowest grid 610 in the stacked/overlapping grids may use a static or near static (infrequently updated) grid layout that provides coverage for larger areas or even global coverage. These large grids have low grid-point density meaning that their spatial resolution is the worst of all the grids in the stack but also require less data usage to update, etc.

In this embodiment, there are three grids in the stack shown with the topmost grid (630) being smaller to provide better localization and having a relatively high grid-point density to provide the best spatial resolution which is useful for areas with larger amounts of ionospheric interference. In other words, the grid layout of the topmost grid 630 is the most dynamic, localized, and accurate among all the grids. The update rate of the ionospheric corrections may also be updated most frequently for the topmost grid 630 to increase the temporal resolution of the correction data. As mentioned above the lower grid(s) may be updated less frequently to save on data usage, etc.

In this embodiment, a middle grid 620 is also utilized. The use of multiple grids may occur in some embodiments to cover certain areas or points of interest, cities, countries, continents, etc. The use of additional grids between the top and bottom grids (610, 630) may also be utilized to provide better resolution, more frequent updates of ionospheric data, etc.

In this example, when a request for ionospheric correction data is received the system refers to its internal databases, etc. to confirm if the topmost grid 630 data is available as it it's the most accurate. If this grid data is not available, the system may then move down the stack of overlapping grids until the ionospheric correction data is found for the request area. If no higher resolution/more frequently updates grid data can be found, the system may default to the lowest grid 610 which is static or near static. These steps may be repeated every time a client requests ionospheric correction data or at certain time intervals, etc.

It should be noted that in some examples, the request for ionospheric correction data may specify the level of accuracy needed and the system may then generate new or improved grids for certain geographical areas based on the said requests.

It should also be noted that the satellite 102 is shown orbiting the Earth 601 is for illustrative purposes and the grid shapes shown are non-limiting. The shape, density, resolution, etc. of the grids utilized may vary between embodiments.

FIG. 7 is another diagram depicting an ionospheric abnormality mitigation system. As shown in FIG. 7, the ionospheric abnormality mitigation system may feature grids corresponding to various geographical locations such as a country, ocean, or continent (Europe 701 in this example). The system utilizes two overlapping grids wherein the larger grid 710 covers a portion of the north Atlantic ocean while the smaller grid 720 covers an area which roughly translates to the country of Iceland. The larger grid 710 is a lower resolution and less frequently updated grid as compared to the Iceland grid 720. This is because the northern Atlantic is sparsely populated and the need to correct positioning data may be lower than a populated country. Thus, the ionospheric abnormality mitigation system in this case will, when receiving a request from a client device, software program, etc., examine the location of the request and then examine which grids are available for use. If an end user is on a ship in the middle of the north Atlantic, the precision of positioning data needed may be less as compared to an automated car driving down the streets of Reykjavik. Thus, the system needs to only maintain the higher-level detailed grid for a smaller area saving on data usage, computing power, etc. In some examples, the number of requests from clients determines the number and level of detail required for various grids. In other examples, the amount of ionospheric interference detected or predicted may also be factored into the system creating and/or using one or more grids to correct for said interference. Such atmospheric interference may be observed in real time or predicted by modeling based on historical data, machine learning, etc. as discussed above (see modeling discussions in FIGS. 1-5).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described herein are also contemplated as may be set forth in some of the appended claims. Although specific terms are employed herein, they are used in a generic and descriptive sense only and not for purposes of limitation.

That which is claimed:

1. A computer-implemented method comprising:
generating, by an ionospheric abnormality mitigation system related to a service provider, prediction data, wherein the prediction data comprises one or more ionospheric activity predictions, and wherein the prediction data is generated based at least in part on one or more ionospheric activity models associated with the ionospheric abnormality mitigation system;
receiving observation data, wherein the observation data comprises data related to current ionospheric activity associated with a particular geographical area;
comparing the prediction data and the observation data;
determining, based in part on results of comparing the prediction data and the observation data, that an ionospheric abnormality is adversely affecting one or more navigational signals associated with the particular geographical area, wherein the particular geographical area is associated with two or more correction grids related to the atmospheric delay correction model, wherein the two or more correction grids at least partially overlap;
generating ionospheric abnormality mitigation data; and
updating at least one of the correction grids with ionospheric abnormality mitigation data, wherein updating at least one of the correction grids comprises executing one or more reconfiguration actions.

2. The computer-implemented method of claim 1, wherein one or more of the correction grids is characterized by a grid layout comprising one or more respective data points.

3. The computer-implemented method of claim 1, wherein the one or more reconfiguration actions comprise updating a correction data update rate defined by the number of client requests received by the service provider for the particular geographical area.

4. The computer-implemented method of claim 1, wherein the one or more reconfiguration actions comprise modifying the grid layout associated with a respective correction grid of the one or more correction grids.

5. The computer-implemented method of claim 1, wherein the one or more reconfiguration actions comprise creating an additional correction grid which overlaps with the two or more existing correction grids.

6. The computer-implemented method of claim 1, wherein the one or more reconfiguration actions are generated based in part on grid point density of a grid for a particular geographical area.

7. The computer-implemented method of claim 1, wherein the computer-implemented method further comprises:
in response to determining that an ionospheric abnormality is adversely affecting the one or more navigational signals associated with the particular geographical area:
generating one or more warning indicators associated with the ionospheric abnormality; and
transmitting the one or more warning indicators to one or more requesting devices associated with the service provider.

8. The computer-implemented method of claim 1, wherein the ionospheric abnormality mitigation system comprises one or more machine learning models configured to generate the prediction modeling data.

9. An apparatus comprised of processing circuitry and at least one memory including computer program code, the at least one memory and the computer program code configured to, with the processing circuitry, cause the apparatus at least to:
generate, by an ionospheric abnormality mitigation system related to a service provider, prediction data, wherein the prediction data comprises one or more ionospheric activity predictions, and wherein the prediction data is generated based at least in part on one or more ionospheric activity models associated with the ionospheric abnormality mitigation system;
receive observation data, wherein the observation data comprises data related to current ionospheric activity associated with a particular geographical area;
compare the prediction data and the observation data;
determine, based in part on results of comparing the prediction data and the observation data, that an ionospheric abnormality is adversely affecting one or more navigational signals associated with the particular geographical area, wherein the particular geographical area is associated with two or more correction grids related to the atmospheric delay correction model, wherein the two or more correction grids at least partially overlap;
generate ionospheric abnormality mitigation data; and
update at least one of the correction grids with ionospheric abnormality mitigation data, wherein updating at least one of the correction grids comprises executing one or more reconfiguration actions.

10. The apparatus of claim 9, wherein one or more of the correction grids is characterized by a grid layout comprising one or more respective data points.

11. The apparatus of claim 9, wherein the one or more reconfiguration actions comprise updating a correction data update rate defined by the number of client requests received by the service provider for the particular geographical area.

12. The apparatus of claim 9, wherein the one or more reconfiguration actions comprise modifying the grid layout associated with a respective correction grid of the one or more correction grids.

13. The apparatus of claim 9, wherein the one or more reconfiguration actions comprise creating an additional correction grid which overlaps with the two or more existing correction grids.

14. The apparatus of claim 9, wherein the one or more reconfiguration actions are generated based in part on grid point density for a grid for a particular geographical area.

15. The apparatus of claim 9, further configured to, in response to determining that an ionospheric abnormality is adversely affecting the one or more navigational signals associated with the particular geographical area:
generate one or more warning indicators associated with the ionospheric abnormality; and
transmit the one or more warning indicators to one or more requesting devices associated with the service provider.

16. The apparatus of claim 9, wherein the ionospheric abnormality mitigation system comprises one or more machine learning models configured to generate the prediction modeling data.
